(19) United States
(12) Patent Application Publication
(10) Pub. No.: US 2014/0346316 A1
(43) Pub. Date: Nov. 27, 2014

(54) CHEST MOUNTED WORKER'S SUPPORT

(71) Applicant: Beau Matthew Sitzmann, Seattle, WA (US)

(72) Inventor: Beau Matthew Sitzmann, Seattle, WA (US)

(21) Appl. No.: 13/901,419

(22) Filed: May 23, 2013

(51) Int. Cl. F16M 13/00

(52) U.S. Cl. CPC F16M 13/005
USPC 248/688

(57) ABSTRACT

A body support device adaptable to support the weight of a user is presented. The body support device comprises a padded support member having a front surface and a rear surface. A plurality of connecting rods is attached with the padded support member. The padded support member is fastened to an upper torso area of the user utilizing a plurality of padded securing straps and may be contoured to fit the anatomy of the user. An elongated extendable member is pivotally connected to the front surface. The elongated extendable member is adaptable to orient in a plurality of directions thereby enabling the user to position in a plurality of different postures. A height adjustable foot member connected to the elongated extendable member telescopically moves along the length of the elongated extendable member to position the user in the plurality of postures.

### CROSS REFERENCES TO RELATED APPLICATIONS

Not Applicable.

### STATEMENT REGARDING FEDERALLY SPONSORED RESEARCH OR DEVELOPMENT

Not Applicable.

### BACKGROUND OF THE DISCLOSURE

The present disclosure relates generally to body support devices, and more particularly, to a body support device for supporting the weight of an upper torso area of a user.

Construction workers, maintenance personnel, landscape maintenance personnel and gardeners have to frequently bend over for accessing horizontal surfaces. For example, in the construction and maintenance fields, the workers have to access the horizontal surface such as a concrete floor or a wooden floor for preparing the surface for attaching the surfacing materials like wood, stone, mineral and clay. The position that one must attain in these construction and maintenance fields is particularly difficult and harmful to one's back.

In the agricultural fields, certain produces like strawberries are commonly picked by field workers using their hands. Therefore, the workers are forced to continuously work in a stooping position for picking these produces and will get suffered from severe back pain. Similarly, the field workers of garden weeding are forced to work close to the ground in the kneeling or stooping position. In order to get rid of these difficulties, the weight of a person working in the kneeling or in the stooping position should be supported.

One such prior art, described in U.S. Pat. No. 4,458,784 issued to Walter on Jul. 10, 1984 provides a body support for use in berry picking, garden weeding and the like for supporting the weight of a person's upper torso when in a kneeling or stooping position. However, it is difficult to use this body support because there is no means for attaching the body support device with the worker. Further, this device lacks a means for supporting the worker without grasping the device whenever a movement from one position to another is needed. Moreover, this body support has complex construction and is very expensive.

U.S. Pat. Application No. 20070007400 entitled to James on Jan. 11, 2007 describes a leaning device for supporting part of a user's front-upper-body. The device has a resting-pad that is supported by a support mechanism. In use, the user stands alongside and leans on and over the resting-pad when leaning over a bed, for example. But this leaning device is only applicable to medical personnel, such as nurses or doctors and does not provide support to agricultural and garden workers.

Therefore, there is a need for a body support device that would be used in construction and maintenance work, garden weeding and the like. Such a needed device would support the weight of a person working in a kneeling or in a stooping position.

Further, such a needed device would reduce the stress on the working person's back without requiring manually grasping the device whenever it is necessary to move from one location to another. Such a needed device would be comfortable to the user and would have simple construction. Moreover, such a needed device would be inexpensive and height adjustable.

SUMMARY OF THE DISCLOSURE

In summary, this invention is a body support device adaptable to support the weight of an upper torso area of a user. The body support device comprises a padded support member having a front surface and a rear surface. A plurality of connecting rods is attached to the padded support member. The padded support member is fastened to the upper torso area utilizing a plurality of padded securing straps. The padded support member may be contoured to provide comfortable support for either male or female users. The body support device further comprises an elongated extendable member that is pivotally connected to the front surface. The elongated extendable member includes a plurality of first apertures, a plurality of second apertures and a plurality of third apertures. The elongated extendable member is adaptable to orient in a plurality of directions thereby enabling the user to position in a plurality of different postures. A height adjustable foot member is connected to the elongated extendable member. The foot member is designed to distribute weight of the upper torso area of the user on a surface onto which the foot member is positioned. The foot member telescopically moves along the length of the elongated extendable member to position the user in the plurality of postures. A tightening member having a plurality of engaging slots is connected to the elongated extendable member.

A plate member is located at the front surface and includes a plurality of plate apertures. The plate member is engaged with the tightening member by inserting at least one of the plurality of plate apertures into the tightening member. Upon engaging the at least one of the plurality of plate apertures with the tightening member, the pin member is inserted into at least one of the plurality of engaging slots to engage the plate member with the tightening member thereby locking the elongated extendable member with the plate member. Locking of the elongated extendable member firmly fixes the foot member on the surface and prevents slipping. The front surface further includes an anchoring means and a locking member for holding the plate member and the when the elongated extendable member respectively when the body support device is not in use.

Accordingly, it is the general object of the present invention to provide a body support device attachable to a user for use in construction and maintenance work, garden weeding and the like for supporting the weight of a person's upper torso when in a kneeling position and in a stooping position.

Another particular object of the present invention is to provide a body support device for reducing the stress on a person's back portion without requiring manually grasping the device whenever it is necessary to move from one location to another.

Another particular object of the present invention is to provide an elongated extendable member designed to orient in a plurality of directions that helps the user to position in a plurality of different postures.

Another object is to provide a body support device that is comfortable and easy to use.

A further object is to provide a body support device that is inexpensive and simple in construction.

Yet another object is to provide a body support device that is height adjustable.

A still further object is to provide a body support device having a foot member that is usable on various hard and soft surfaces.

These and other advantages and features of the present invention are described with specificity so as to make the present invention understandable to one of ordinary skill in the art.

### BRIEF DESCRIPTION OF THE DRAWINGS

In order to enhance their clarity and improve understanding of these various elements and embodiments of the invention, elements in the figures have not necessarily been drawn to scale. Furthermore, elements that are known to be common and well understood to those in the industry are not depicted in order to provide a clear view of the various embodiments of the invention, thus the drawings are generalized in form in the interest of clarity and conciseness.

FIG. 1 is a perspective view of the present invention, illustrating a body support device for supporting the weight of an upper torso area of a user;

FIG. 2 is a perspective view of the present invention, illustrating an elongated extendable member and a plate member of the body support device;

FIGS. 3 and 4 illustrate the body support device while in use;

FIG. 5 is a perspective view of the present invention, illustrating an anchoring means for holding the plate member of the body support device;

FIG. 6 is a perspective view of the present invention, illustrating a locking member and a locking screw of the body support device; and

FIG. 7 is a perspective view of the present invention, illustrating the body support device in a locked state.

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way. Among other things, the following invention may be embodied as methods or devices. The following detailed descriptions should not be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

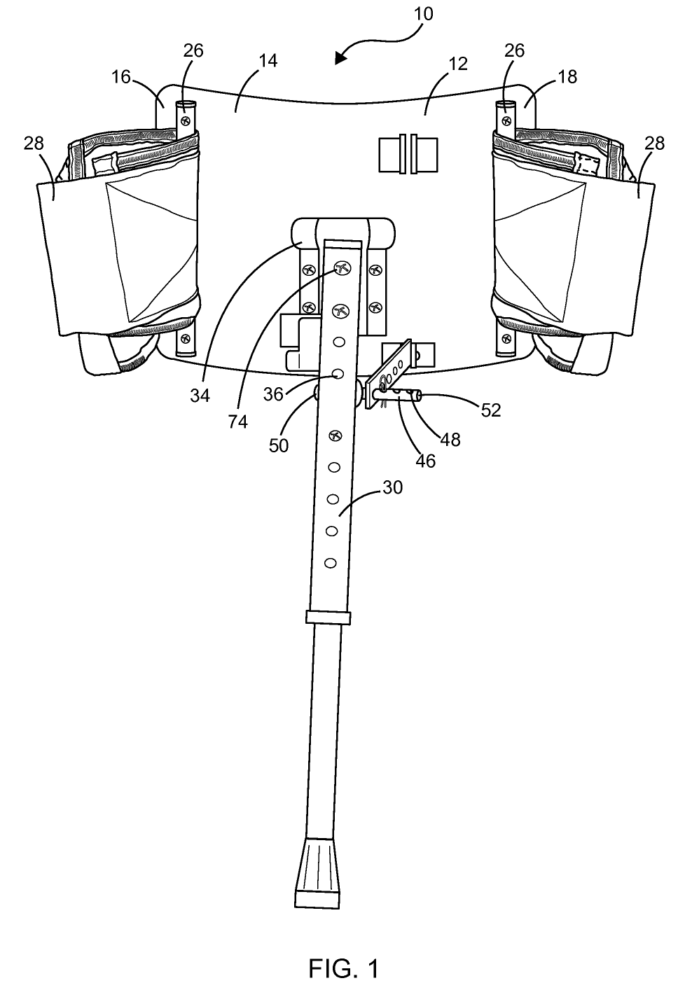

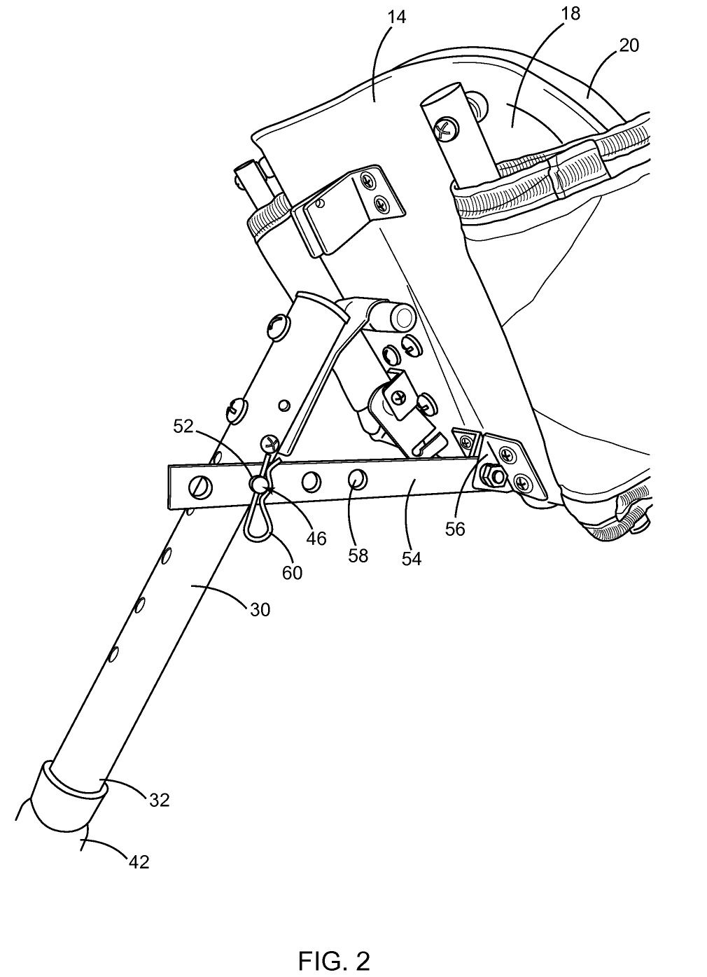

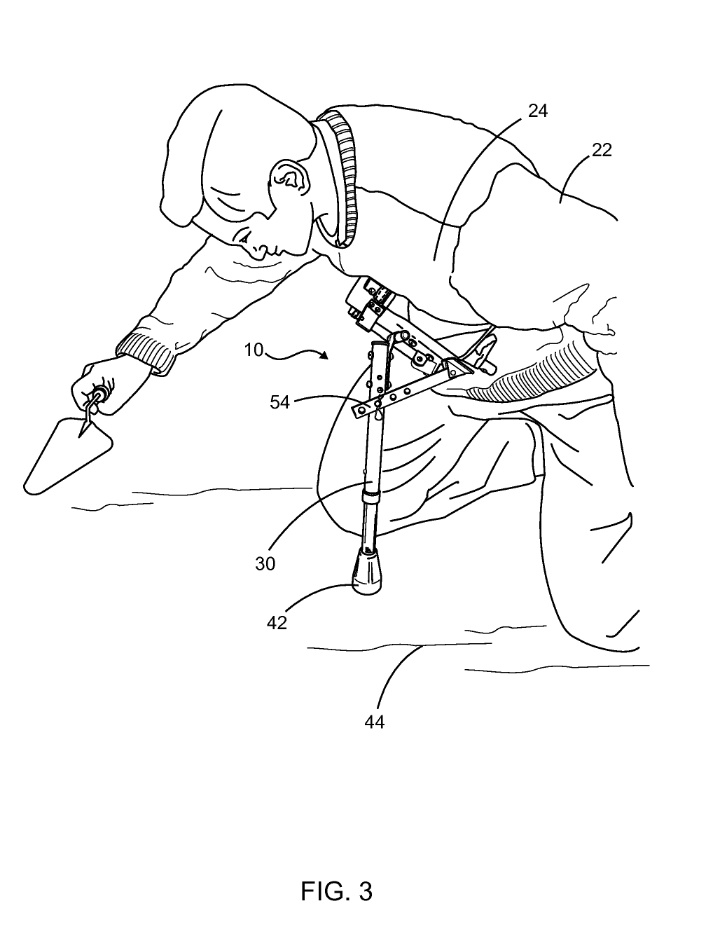

Referring to FIGS. 1-7, a body support device 10 adaptable to support the weight of an upper torso area 24 (FIG. 3) of a user 22 is illustrated. The body support device 10 comprises a padded support member 12 designed to attach to the upper torso area 24. The user 22 may be a worker who has to work in difficult postures like kneeling. As best illustrated in FIG. 1, the padded support member 12 includes a front surface 14 and a rear surface 20 (FIG. 2). While in use, the rear surface 20 comes in direct contact with the upper torso area 24 of the user 22. The front surface 14 includes a first side 16 and a second side 18. A plurality of connecting rods 26 is attached to the padded support member 12. At least one of the plurality of connecting rods 26 is attached to the first side 16 and to the second side 18 of the front surface 14. In the preferred embodiment, the body support device 10 provides support to the chest of the user 22.

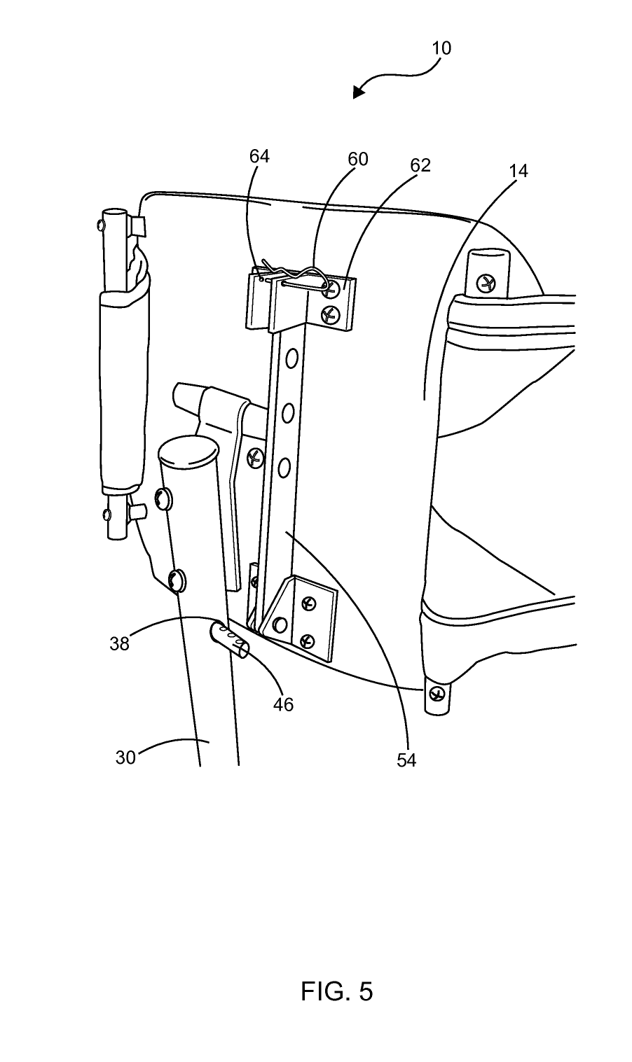

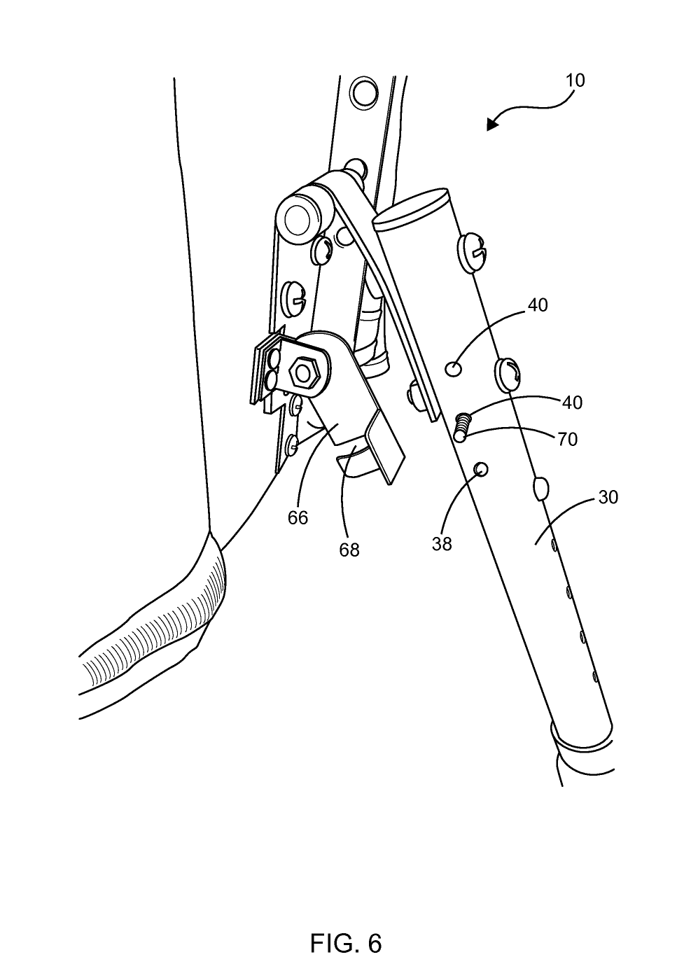

The body support device 10 further comprises a plurality of padded securing straps 28 for fastening the padded support member 12 with the upper torso area 24. At least one of the plurality of padded securing straps 28 is connected to the plurality of connecting rods 26. An elongated extendable member 30 is pivotally connected to the front surface 14 utilizing a first connecting member 34. The elongated extendable member 30 includes a plurality of first apertures 36, a plurality of second apertures 38 (FIG. 5) and a plurality of third apertures 40 (FIG. 6). The elongated extendable member 30 is designed to orient in a plurality of directions that enables the user 22 to position in a plurality of different postures like kneeling or stooping. The elongated extendable member 30 is connected to the first connecting member 34 utilizing a plurality of third connecting members 74. The plurality of third connecting members 74 may be a screw. A tightening member 46 is connected to the elongated extendable member 30 through the plurality of second apertures 38 (FIG. 5). The tightening member 46 includes a plurality of engaging slots 48, a first end portion 50 and a second end portion 52. The body support device 10 further comprises a height adjustable foot member 42 connected to a lower portion 32 of the elongated extendable member 30.

Referring to FIG. 2, the front surface 14 further includes a plate member 54. The plate member 54 and the front surface 14 are connected together with a second connecting member 56. The plate member 54 includes a plurality of plate apertures 58. At least one of the plurality of plate apertures 58 is inserted into the second end portion 52 for engaging the plate member 54 with the tightening member 46. The body support device 10 further comprises a pin member 60. The pin member 60 is designed to insert into at least one of the plurality of engaging slots 48 (FIG. 5) to lock the plate member 54 with the tightening member 46. When the plate member 54 gets engaged with the tightening member 46, the elongated extendable member 30 becomes locked with the plate member 54.

The height adjustable foot member 42 distributes the weight of the upper torso area 24 on a surface 44 onto which the foot member 42 is positioned. The height adjustable foot member 42 telescopically moves along the length of the elongated extendable member to position the user 22 in the plurality of postures. Depending upon the convenience of the user 22, length of the foot member 42 is extended or retracted. As shown in FIG. 3, the user 22 is working in the kneeling posture. Since the plate member 54 is locked with the elongated extendable member 30, the height adjustable foot member 42 gets firmly fixed on the surface 44. This prevents the height adjustable foot member 42 from sliding, while providing support for the worker. The foot member 42 is designed to attach on hard and soft surfaces. The pivotal orientation of the elongated extendable member 30 in multiple directions allows the user 22 to quickly switch from one comfortable posture to another.

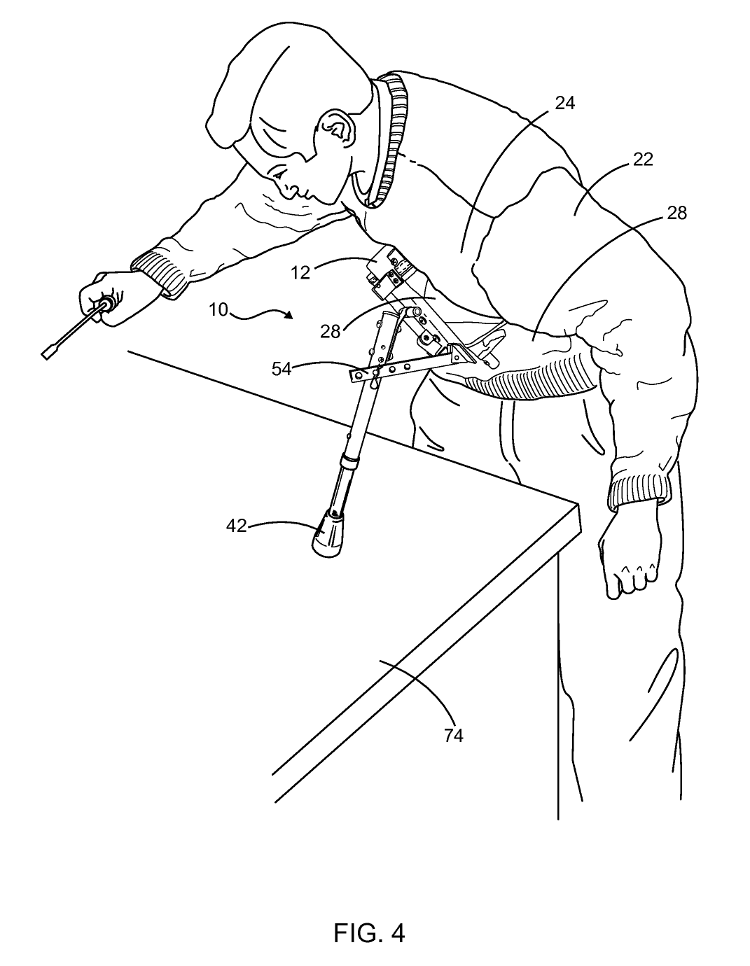

Referring to FIG. 4, the user 22 in a standing position and the height adjustable foot member 42 is positioned on a table surface 74. The device 10 enables the user 22 to comfortably work in this position for an extended period of time. The padded support member 12 and the plurality of padded securing straps 28 are made of soft cushion material to provide additional comfort to the user 22.

When the body support device 10 is not in use, the plate member 54 and the elongated extendable member 30 are locked. With reference to FIGS. 5-7, the front surface 14 includes an anchoring means 62 for securely holding the plate member 54. The anchoring means 62 includes a plurality of securing holes 64. The plate member 54 and the anchoring means 62 are engaged together by inserting the pin member 60 into the plurality of securing holes 64. The tightening member 46 is connected to the elongated extendable member 30 utilizing the plurality of second apertures 38 as illustrated in FIGS. 5 and 6.

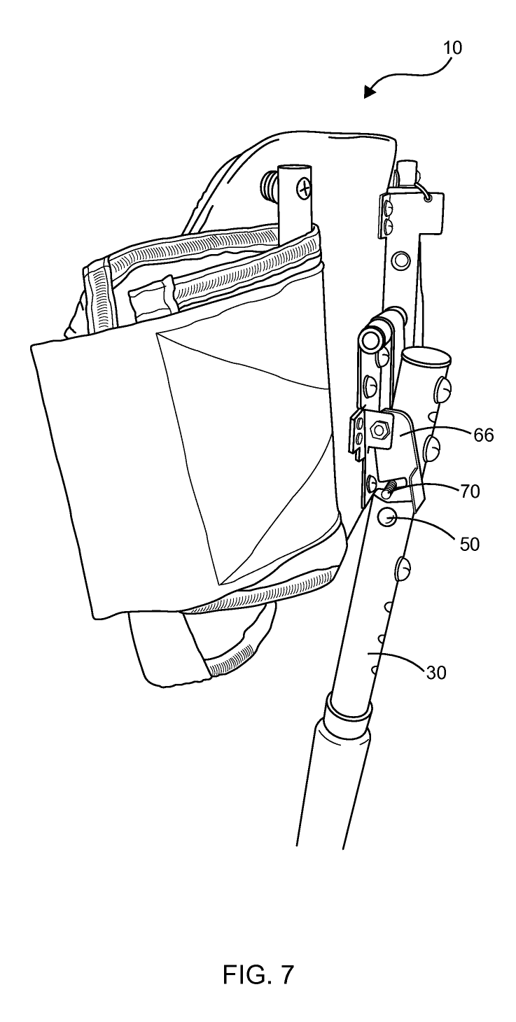

Referring to FIGS. 6 and 7, the body support device 10 further comprises a locking member 66 and a locking screw 70. To lock the elongated extendable member 30, the locking member 66 features a locking slot 68. The locking screw 70 is designed to insert through the plurality of third apertures 40 and the locking slot 68. The locking screw 70 locks the elongated extendable member 30 with the locking member 66.

The invention may be embodied in other forms without departure from the spirit and essential characteristics thereof. The embodiments described therefore are to be considered in all respects as illustrative and not restrictive. Although the present invention has been described in terms of certain preferred embodiments, other embodiments that are apparent to those of ordinary skill in the art are also within the scope of the invention.

What is claimed is:

1. A body support device, comprising:
(a) a padded support member having a front surface and a rear surface;
(b) a plurality of connecting rods attached to the padded support member;
(c) a plurality of padded securing straps for fastening the padded support member to an upper torso area of a user, at least one of the plurality of padded securing straps being connected to the plurality of connecting rods;
(d) an elongated extendable member pivotally connected to the front surface of the padded support member, the elongated extendable member includes a plurality of first apertures, a plurality of second apertures and a plurality of third apertures, the elongated extendable member being adaptable to orient in a plurality of directions thereby enabling the user to position in a plurality of different postures;
(e) a height adjustable foot member connected to the elongated extendable member, the foot member being designed to distribute weight of the upper torso area of the user on a surface, the height adjustable foot member telescopically moves along the length of the elongated extendable member to position the user in the plurality of postures;
(f) a tightening member having a plurality of engaging slots, the tightening member being connected to the elongated extendable member through the plurality of second apertures;
(g) a plate member having a plurality of plate apertures, the plate member being engaged with the tightening member by inserting at least one of the plurality of plate apertures into the tightening member;
(h) a pin member designed to insert into at least one of the plurality of engaging slots to engage the plate member with the tightening member thereby locking the elongated extendable member with the plate member, locking of the elongated extendable member enables the foot member to firmly fix on the surface without slipping;
(i) an anchoring means located at the front surface; and
(j) a locking member attached with the front surface, the locking member includes a locking slot;
whereby the height adjustable foot member adjusts the length of the elongated extendable member to orient in the plurality of directions and enables the user to position in the plurality of postures without slipping.

2. The body support device of claim 1 wherein the body support device further comprises a locking screw.

3. The body support device of claim 2 wherein the locking screw is inserted through the plurality of third apertures and the locking slot to engage the elongated extendable member with the locking member when the body support device is not in use.

4. The body support device of claim 1 wherein the padded support member further includes a first connecting member, a second connecting member, a first side and a second side.

5. The body support device of claim 4 wherein the first connecting member is utilized to connect the elongated extendable member to the front surface.

6. The body support device of claim 4 wherein the second connecting member is utilized to connect the plate member to the front surface.

7. The body support device of claim 1 wherein the elongated extendable member further includes a plurality of third connecting members to connect the elongated extendable member to the first connecting member.

8. The body support device of claim 1 wherein at least one of the plurality of connecting rods is attached at the first side and at the second side of the padded support member.

9. The body support device of claim 1 wherein the anchoring means includes a plurality of securing holes designed to receive the pin member for connecting the plate member to the anchoring means when the body support device is not in use.

10. The body support device of claim 1 wherein the rear surface and the plurality of padded securing straps are made of soft cushion material.

11. The body support device of claim 1 wherein the height adjustable foot member is connected to a lower portion of the elongated extendable member.

12. The body support device of claim 1 wherein the tightening member further includes a first end portion and a second end portion.

13. The body support device of claim 12 wherein the second end portion receives the at least one of the plurality of plate apertures.

14. A body support device, comprising:
(a) a padded support member adaptable to attach with an upper torso area of a user, the padded support member includes a front surface and a rear surface;
(b) a plurality of connecting rods attached to the padded support member;
(c) a plurality of padded securing straps for fastening the padded support member to the upper torso area, at least one of the plurality of padded securing straps being connected to the plurality of connecting rods;
(d) an elongated extendable member pivotally connected to the front surface utilizing a first connecting member, the elongated extendable member includes a plurality of first apertures, a plurality of second apertures and a plurality of third apertures, the elongated extendable member being adaptable to orient in a plurality of directions thereby enabling the user to position in a plurality of different postures;
(e) a height adjustable foot member connected to a lower portion of the elongated extendable member, the foot member being designed to distribute weight of the upper torso area of the user on a surface and telescopically moves along the length of the elongated extendable member to position the user in the plurality of postures;
(f) a tightening member having a plurality of engaging slots, the tightening member being connected to the elongated extendable member through the plurality of second apertures;
(g) a plate member connected to the front surface utilizing a second connecting member, the plate member includes a plurality of plate apertures, the plate member being engaged with the tightening member by inserting at least one of the plurality of plate apertures into the second end portion of the tightening member;
(h) a pin member designed to insert into at least one of the plurality of engaging slots to engage the plate member with the tightening member thereby locking the elongated extendable member with the plate member, locking of the elongated extendable member enables the foot member to firmly fix on the surface without slipping;
(i) an anchoring means located at the front surface for securely holding the plate member; and
(j) a locking member attached to the front surface, the locking member includes a locking slot;
whereby the height adjustable foot member adjusts the length of the elongated extendable member to orient in the plurality of directions and enables the user to position in the plurality of postures without slipping.

15. The body support device of claim 14 wherein the body support device further comprises a locking screw.

16. The body support device of claim 15 wherein the locking screw is inserted through the plurality of third apertures and the locking slot for engaging the elongated extendable member with the locking member when the body support device is not in use.

17. The body support device of claim 14 wherein the front surface further includes a first side and a second side.

18. The body support device of claim 17 wherein the first side and the second side are attached with at least one of the plurality of connecting rods.

19. The body support device of claim 14 wherein the tightening member further includes a first end portion and a second end portion.

20. The body support device of claim 19 wherein the second end portion receives the at least one of the plurality of plate apertures.

21. The body support device of claim 14 wherein the anchoring means securely holds the plate member when the body support device is not in use.
